(19) United States
(12) Patent Application Publication
(10) Pub. No.: US 2025/0085800 A1
(43) Pub. Date: Mar. 13, 2025

(54) Electronic Devices With Proximity Sensors

(71) Applicant: Apple Inc., Cupertino, CA (US)

(72) Inventors: Yifei Wang, Opfikon (CH); Shahrzad Pouryayevali, Zurich (CH); Pablo Caballero Garces, Santa Clara, CA (US)

(21) Appl. No.: 18/671,116

(22) Filed: May 22, 2024

Related U.S. Application Data
(60) Provisional application No. 63/581,534, filed on Sep. 8, 2023.

(51) Int. Cl. G06F 3/041; G01C 21/16; G06F 3/01

(52) U.S. Cl. CPC G06F 3/0416; G01C 21/16; G06F 3/012; G06F 2203/04106

(57) ABSTRACT

An electronic device may include a proximity sensor and a display. In particular, the display may be deactivated when the device is near a user's head. However, the proximity sensor may operate through or near the display and may detect the user's finger. Therefore, to distinguish between the user's finger and head, a motion sensor, such as an inertial measurement unit (IMU) may be used. For example, the position, acceleration, and rate of rotation of the device may be measured by the IMU, and a machine-learning algorithm may take the position, acceleration, and rate of rotation as inputs to determine whether the proximity sensor is triggered by the user's finger or head. In response to determining that the proximity has been triggered by the head, the display may be deactivated. Alternatively, in response to determining that the proximity sensor has been triggered by the finger, the display may remain on.

This application claims the benefit of U.S. provisional patent application No. 63/581,534, filed Sep. 8, 2023, which is hereby incorporated by reference herein in its entirety.

### FIELD

This relates generally to electronic devices, including electronic devices with sensors.

### BACKGROUND

Electronic devices such as laptop computers, cellular telephones, and other equipment are sometimes provided with various components. The components may be adjusted based on sensor measurements.

### SUMMARY

An electronic device may include a proximity sensor and a display. In particular, it may be desirable for the display to be deactivated when the device is near a user's head (e.g., the user has brought the device to their head to make a phone call) to prevent erroneous input on the display. However, the proximity sensor may operate through or near the display and may also be triggered when the user's finger (or other external object, such as a stylus) when the user interacts with the display.

To distinguish between the user's head and finger, a motion sensor, such as an inertial measurement unit (IMU) may be used. For example, the position, acceleration, and rate of rotation of the device may be measured by the IMU. A machine-learning algorithm may take the position, acceleration, and rate of rotation as inputs to determine whether the proximity sensor is triggered by the user's finger or head.

In response to determining that the proximity has been triggered by the user's head, the display may be deactivated, such as by deactivating a touch sensor and/or an array of pixels of the display. Alternatively, in response to determining that the proximity sensor has been triggered by the finger, the display (e.g., the touch sensor and/or the array of pixels) may remain on.

Other sensor information, such as ambient light measurements and/or touch sensor measurements, may also be used to determine whether the proximity sensor has been triggered by the user's finger (or other external object) or the user's head.

### BRIEF DESCRIPTION OF THE DRAWINGS

FIG. 1 is a schematic diagram of an illustrative electronic device having a display and sensor components in accordance with some embodiments.

FIG. 2 is a perspective view of an electronic device with a display and a proximity sensor in accordance with some embodiments.

FIG. 3 is a side view of an electronic device with a proximity sensor that operates through a display layer in accordance with some embodiments.

FIGS. 4A-4C are graphs of illustrative relationships between electronic device position, acceleration, and rate of rotation, respectively, over time when a proximity sensor is triggered by a user's finger and when the proximity sensor is triggered by the user's head in accordance with some embodiments.

FIG. 5 is a diagram of illustrative proximity and motion sensor components used to determine whether the proximity sensor is triggered by a finger or head in accordance with some embodiments.

FIG. 6 is a diagram of illustrative steps that may be used to determine whether the proximity sensor is triggered by a finger or head in accordance with some embodiments.

FIG. 7 is a flowchart of illustrative method steps that may be used to determine whether the proximity sensor is triggered by a finger or head in accordance with some embodiments.

### DETAILED DESCRIPTION

Electronic devices, such as cellular telephones, tablets, and wearable devices, may have a display. It may be desirable to include a proximity sensor in the electronic devices to sense when a user has the device against their head (e.g., to make a phone call) and to turn off/deactivate the display when the device is against the user's head. However, the proximity sensor may be near or under the display. As a result, the proximity sensor may detect not only when the device is against the user's head, but also when an external object, such as the user's finger is near the proximity sensor (e.g., when the user is interacting with the display). Therefore, it may be desirable to determine whether the proximity sensor is triggered due to the user's head or due to a finger or other external object.

To determine whether the proximity sensor is triggered due to a head or other external object, a motion sensor, such as an inertial measurement unit (IMU), may make measurements both before and after the proximity sensor is triggered. For example, the IMU may make repeated measurements at a given frequency while the electronic device is on, therefore providing data before and after the proximity sensor is triggered.

The IMU data from a time period just before the proximity sensor was triggered may be used to determine whether the proximity sensor was triggered due to the user's head or due to another object. In response to determining that the proximity sensor was triggered by the user's head, the display may be turned off/deactivated to prevent inadvertent touch input to the display. Alternatively, in response to determining that the proximity sensor was triggered by an external object, such as the user's finger, the display may be left on to allow the user to continue interacting with the display.

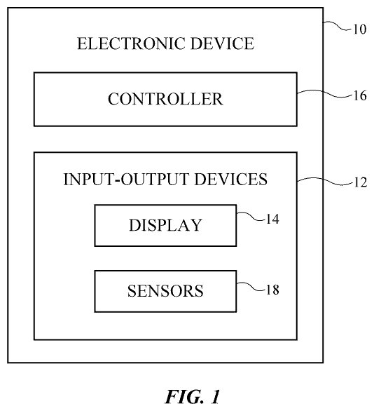

An illustrative electronic device of the type that may be provided with a proximity sensor and a display is shown in FIG. 1. Electronic device 10 may be a computing device such as a laptop computer, a computer monitor containing an embedded computer, a tablet computer, a cellular telephone, a media player, or other handheld or portable electronic device, a smaller device such as a wristwatch or other device worn on a user's wrist, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment.

As shown in FIG. 1, electronic device 10 may have controller 16 (also referred to as control circuitry herein). Controller 16 may include storage and processing circuitry for supporting the operation of device 10. The storage and processing circuitry may include storage such as hard disk drive storage, nonvolatile memory (e.g., flash memory or other electrically-programmable-read-only memory configured to form a solid-state drive), volatile memory (e.g., static or dynamic random-access-memory), etc. Processing circuitry in controller 16 may be used to control the operation of device 10. The processing circuitry may be based on one or more microprocessors, microcontrollers, digital signal processors, baseband processors, power management units, audio chips, application specific integrated circuits, etc. Controller 16 may include communications circuitry for supporting wired and/or wireless communications between device 10 and external equipment. For example, controller 16 may include wireless communications circuitry such as cellular telephone communications circuitry and wireless local area network communications circuitry. The communications circuitry may include one or more antennas that send and/or receive data or other information from external sources.

Input-output devices 12 may be used to allow data to be supplied to device 10 and to allow data to be provided from device 10 to external devices. Input-output devices 12 may include buttons, joysticks, scrolling wheels, touch pads, key pads, keyboards, microphones, speakers, tone generators, vibrators, cameras, light-emitting diodes and other status indicators, data ports, etc. A user may control the operation of device 10 by supplying commands through input-output devices 12 and may receive status information and other output from device 10 using the output resources of input-output devices 12.

Input-output devices 12 may include one or more displays such as display 14. Display 14 may be a touch screen display that includes a touch sensor for gathering touch input from a user (e.g., a user's finger, a stylus, or other input device) or display 14 may be insensitive to touch. A touch sensor for display 14 may be based on an array of capacitive touch sensor electrodes, acoustic touch sensor structures, resistive touch components, force-based touch sensor structures, a light-based touch sensor, or other suitable touch sensor arrangements. Display 14 may be include any desired display technology, and may be an organic light-emitting diode (OLED) display, a liquid crystal display (LCD), a microLED display, or any other desired type of display.

Sensors 18 may include a light-based proximity sensor, a capacitive proximity sensor, a magnetic proximity sensor, an ultrasonic proximity sensor, a photoelectric proximity sensor, a magnetic sensor (e.g., a magnetometer or a compass), an inertial measurement sensor, an accelerometer or other motion sensor, a force sensor, a touch sensor, a temperature sensor, a pressure sensor, a microphone, a radio-frequency sensor, a three-dimensional image sensor, an ambient light sensor, a camera, a light-based position sensor (e.g., a lidar sensor), and/or other sensors. Sensors 18 may include one or more of each of these sensors, if desired. A battery in device 10 may store power that is used to power display 14, sensors 18, and other components of device 10.

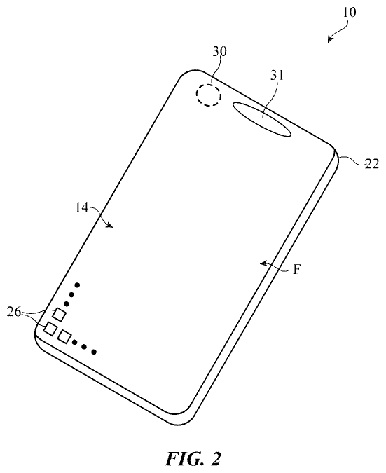

A perspective view of an illustrative electronic device of the type that may include a proximity sensor and a display is shown in FIG. 2. In the example of FIG. 2, device 10 includes a display such as display 14 mounted in housing 22. Display 14 may be a liquid crystal display, an electrophoretic display, an organic light-emitting diode display, or other display with an array of light-emitting diodes (e.g., a display that includes pixels having diodes formed from crystalline semiconductor dies), may be a plasma display, may be an electrowetting display, may be a display based on microelectromechanical systems (MEMs) pixels, or may be any other suitable display. Display 14 may have an array of pixels 26 that extends across some or all of front face F of device 10 and/or other external device surfaces. The pixel array may be rectangular or may have another suitable shape. Display 14 may be protected using a display cover layer (e.g., a transparent front housing layer) such as a layer of transparent glass, clear plastic, sapphire, or another transparent layer. The display cover layer may overlap the array of pixels 26.

Housing 22, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 22 and display 14 may separate an interior region of device 10 from an exterior region surrounding device 10. Housing 22 may be formed using a unibody configuration in which some or all of housing 22 is machined or molded as a single structure or may be formed using multiple structures (e.g., an internal frame structure, one or more structures that form exterior housing surfaces, etc.).

Pixels 26 may cover substantially all of the front face of device 10 or display 14 may have inactive areas (e.g., notches, recessed areas, islands rectangular areas, or other regions) that are free of pixels 26. The inactive areas may be used to accommodate an opening for a speaker and windows for optical components such as one or more image sensors, ambient light sensors, optical proximity sensors, three-dimensional image sensors such as structured light three-dimensional image sensors, and/or a camera flash, etc. In an illustrative configuration, pixels 26 may extend over front surface F of device 10 and may overlap proximity sensor 30. In this type of arrangement, proximity sensor 30 may detect whether an external object (e.g., a user's face or finger) is in close proximity to display 14 by operating through display 14. Alternatively, proximity sensor 30 may be in an inactive area of display 14.

Device 10 may also include speaker 31. Speaker 31 may be surrounded by pixels 26 of display 14 or may be formed in an inactive area of display 14. Speaker 31 may produce audio for a user when the user is using device 10 to make a phone call, listen to a voicemail, and/or interact with a virtual assistant, as examples.

In operation, display 14 may be on (activated). When a user brings device 10 up to their head to listen to audio from speaker 31, it may be desirable to turn off (deactivate) display 14 to prevent errant touches on the display. For example, a touch sensor of display 14 and/or an array of pixels of display 14 may be turned off (and/or a portion of the touch sensor and/or the array of pixels may be turned off). Therefore, proximity sensor 30 may be used to determine the presence of the user's head. However, other external objects, such as the user's finger, a stylus, or other object, may be detected by proximity sensor 30, such as when the user is interacting with display 14. Therefore, to determine whether proximity sensor 30 has detected the user's head or another object, measurements from an inertial measurement unit (IMU) in device 10 may be used. In particular, data from the IMU, such as position, acceleration, and/or rotation data, from just before the proximity sensor is triggered may be used. If proximity sensor 30 was triggered by the user's head, display 14 may be deactivated. If proximity sensor 30 was triggered by another object, such as the user's finger, display 14 may remain activated.

Although the user's finger is described throughout as triggering proximity sensor 30, this is merely illustrative. In general, proximity sensor 30 may detect any suitable external object, such as a stylus.

Although FIG. 2 shows electronic device 10 as a cellular telephone, this arrangement is merely illustrative. In general, electronic device 10 may be any electronic device. For example, device 10 may be a wearable device, such as a wristwatch device or a head-mounted device.

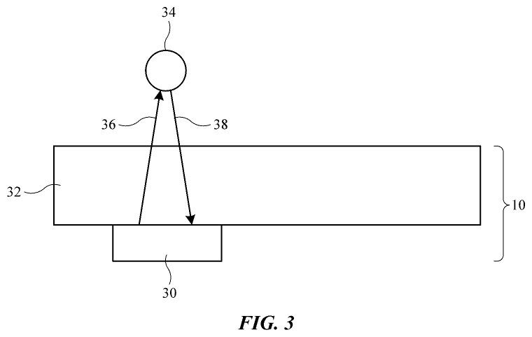

Regardless of the type of device of device 10, proximity sensor 30 may be an optical proximity sensor. An illustrative example of an electronic device with an optical proximity sensor is shown in FIG. 3.

As shown in FIG. 3, proximity sensor 30 in device 10 may operate through layer 32. Layer 32 may include a transparent layer of device 10, such as a transparent cover layer that overlaps a display, a layer with a transparent opening, and/or one or more display layers, as examples. In some illustrative examples, proximity sensor 30 may operate through a display (e.g., layer 32 may be display 14 of FIGS. 1 and 2).

In operation, proximity sensor 30 may emit light 36, such as using a light-emitting diode or other light source. Light 36 may be infrared light, near-infrared light, or other suitable light. Light 36 may reflect off of external object 34 as light 38. Proximity sensor 30 may detect light 38 after it passes through layer 32, such as using a photodetector that is sensitive to the wavelength of light 36 and 38. In particular, by determining the amount of time between proximity sensor 30 emitting light 36 and detecting light 38, control circuitry in device 10 may determine the proximity of external object 34.

Although proximity sensor 30 is shown in FIG. 3 as an optical proximity sensor, this is merely illustrative. In general, proximity sensor 30 may be a light-based proximity sensor, a capacitive proximity sensor, a magnetic proximity sensor, an ultrasonic proximity sensor, a photoelectric proximity sensor, or another suitable proximity sensor.

External object 34 may be a user's head, a user's finger, or other external object. In some embodiments, it may be desirable to deactivate a display (e.g., display 14 of FIGS. 1 and 2) in device 10 if external object 34 is a user's head (e.g., if the user has brought device 10 to their head/ear), while leaving the display on/activated if external object is a user's finger or another external object.

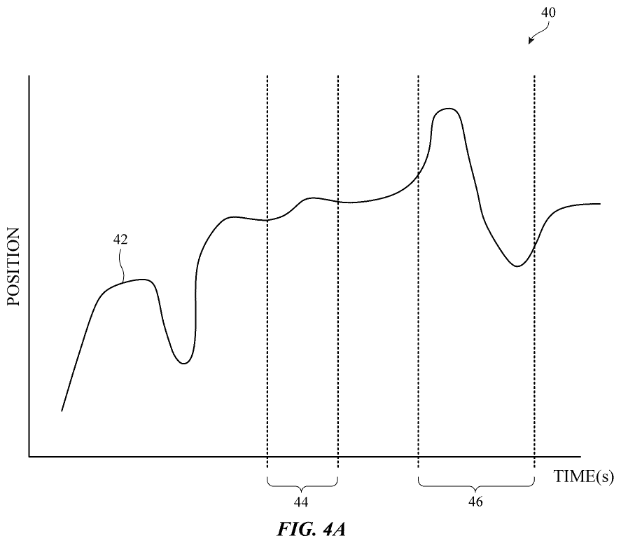

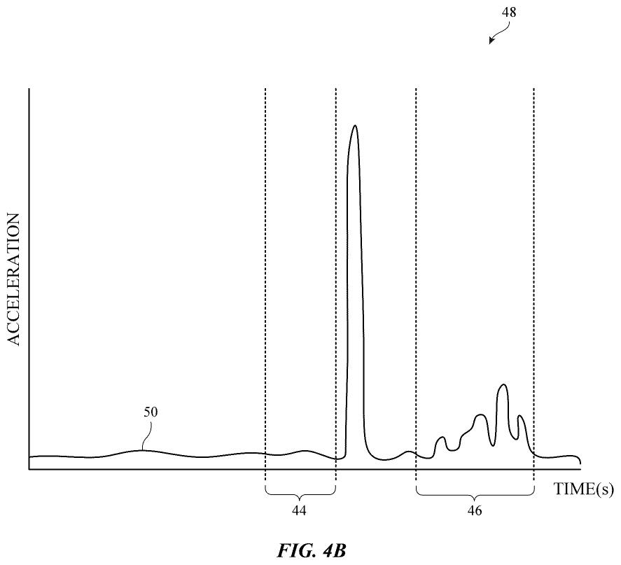

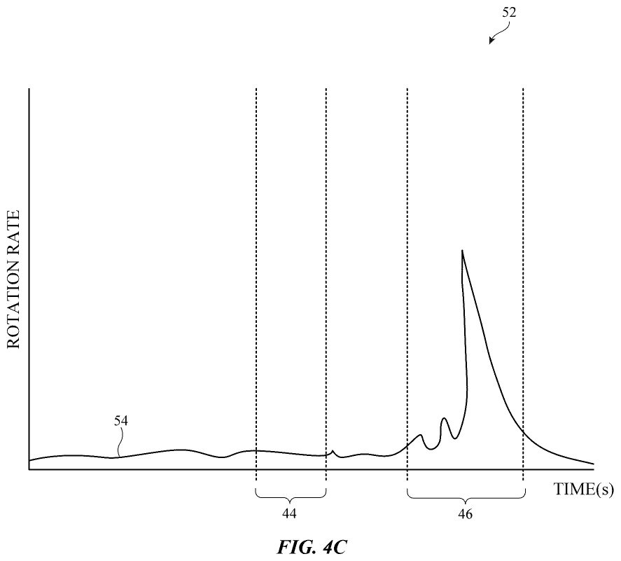

To determine whether external object 34 is a user's head or another external object, data from other sensors in device 10 in the time period just before proximity sensor 30 detects object 34 may be used. In some illustrative embodiments, data from one or more motion sensors, such as an inertial measurement unit (IMU), may be used. The IMU may include one or more accelerometers, gyroscopes, magnetometers, and/or other motions sensors. Illustrative examples of IMU data that may indicate whether the user has brought device 10 to their head (and the display should be deactivated) are shown in FIGS. 4A-4C.

As shown in FIG. 4A, graph 40 includes curve 42. Curve 42 is an illustrative relationship of the position of an electronic device (such as housing 22 of device 10 of FIGS. 1-3) over time. The illustrative position of the device housing over time may be the relative device position in a vertical direction (e.g., Z direction) and/or one or more horizontal directions (e.g., an X and/or Y direction). In other words, the changes of curve 42 may be the relative position changes of the device housing with respect to itself.

Time period 44 may correspond with a time period in which the user has touched the display with their finger or another external object, such as a stylus. In particular, time period 44 may span ¼ seconds, ½ seconds, ¾ seconds, 1 second, or other time period before proximity sensor 30 has detected the finger or other external object. As shown in graph 40, the relative position of device 10 may remain relatively constant in time period 44.

Time period 46, on the other hand, may correspond with a time period in which the user has raised the electronic device to their head (e.g., to take a phone call). In particular, time period 46 may span ¼ seconds, ½ seconds, ¾ seconds, 1 second, or other time period before proximity sensor 30 has detected the user's head. In time period 46, the relative position of device 10 may change much more than in time period 44. For example, the user may have to raise the device vertically to their head, and this change in distance may be measured by the IMU during time period 46. Therefore, the change in relative position of device 10 in a time period just before a proximity sensor is triggered may indicate whether a user has touched the display with their finger or brought the device to their head.

Another illustrative example of IMU data that may be used to distinguish between a user's finger and the device being raised to the user's head is shown in FIG. 4B. As shown in FIG. 4B, graph 48 includes curve 50. Curve 50 is an illustrative relationship of the acceleration of an electronic device (such as device 10 of FIGS. 1-3) over time. In time period 44, the electronic device may have a small acceleration, which may indicate that the user has touched the display with their finger or other object. In contrast, in time period 46, the electronic device may have a large acceleration, which may indicate that the user has raised the device to their head. In particular, the user may accelerate the device when they lift the device to their head, and the acceleration of the device may be measured by the IMU during time period 46. Therefore, the change in acceleration of device 10 in a time period just before a proximity sensor is triggered may indicate whether a user has touched the display with their finger or brought the device to their head.

A third illustrative example of IMU data that may be used to distinguish between a user's finger and the device being raised to the user's head is shown in FIG. 4C. As shown in FIG. 4C, graph 52 includes curve 54. Curve 54 is an illustrative relationship of the rotation rate of an electronic device (such as device 10 of FIGS. 1-3) over time. In time period 44, the electronic device may have a small rotation rate, which may indicate that the user has touched the display with their finger or other object. In contrast, in time period 46, the electronic device may have a large rotation rate, which may indicate that the user has raised the device to their head. In particular, the user may rotate the device when they lift the device to their head, and the rate of rotation of the device may be measured by the IMU during time period 46. Therefore, the rate of rotation of device 10 in a time period just before a proximity sensor is triggered may indicate whether a user has touched the display with their finger or brought the device to their head.

The relationships between position, acceleration, and/or rotation vs. time of FIGS. 4A, 4B, and 4C, respectively, may be determined from IMU measurements directly, or may be calculated from IMU data. For example, the position of the device may be determined from multiple position measurements of the electronic device (e.g., may include a rolling average of position measurements, may include a standard deviation of position measurements, etc.). The acceleration of the device may be based on a rolling average of acceleration measurements. The rotation rate of the device may be determined from a gyroscope in the IMU, and the rotate rate relationship over time may be based on a rolling average of acceleration measurements. However, these examples are merely illustrative. In general, any IMU data and/or other motion sensor data may be used in any suitable manner to determine whether a sensed external object is a user's finger or head.

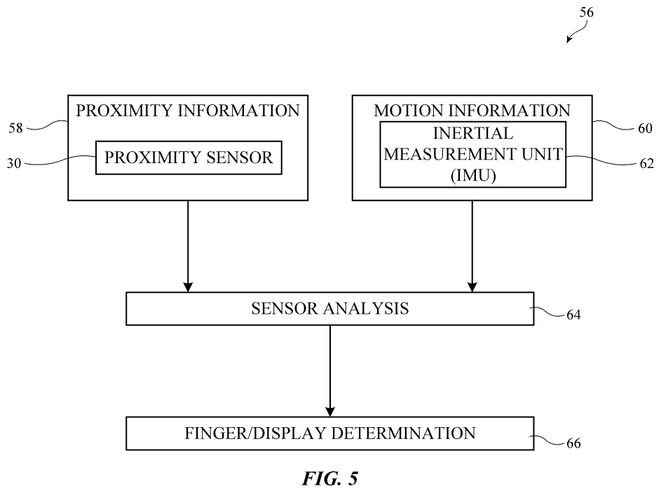

Regardless of the IMU data used, illustrative schematic diagram 56 in FIG. 5 shows how proximity information 58 may be obtained from proximity sensor 30 and motion information 60 may be obtained from IMU 62. In particular, proximity sensor 30 may generate signals in response to detecting an external object (e.g., external object 34 of FIG. 3), such as by emitting light and detecting light that has reflected from the external object or by sensing the external object capacitively. In general, proximity sensor 30 may be triggered when an external object comes into close enough proximity to proximity sensor 30 (e.g., within a predetermined threshold).

IMU 62 may generate signals in response to motion of the device (e.g., motion of the housing of the device), such as device 10 of FIGS. 1-3. IMU 62 may include one or more accelerometers, gyroscopes, and/or magnetometers to measure the motion of the device. The motion signals and the proximity signals may be analog or digital signals, and may form motion data and proximity data, respectively.

Sensor analysis 64 may analyze the signals/data generated by proximity sensor 30 and IMU 62. In particular, a controller, such as controller 16 in device 10 (FIG. 1), may determine when proximity sensor 30 is triggered (e.g., when proximity sensor 30 detects the presence of an external object). In response to the triggering of proximity sensor 30, the controller may analyze the motion data generated by IMU 62 in a time period just before proximity sensor 30 was triggered, such as a time period of 0.25 s, 0.5 s, 0.75 s, 1 s, or 1.5 s, as examples, to determine whether the detected external object was the user's finger or the user's head.

To make this determination, a machine-learning algorithm may be used to correlate the motion data from IMU 62 to whether proximity sensor 30 was triggered due to the user's finger or the user lifting the device to their head. For example, a gradient boosted tree algorithm, random forest algorithm, decision tree algorithm, support vector machine algorithm, multi-layer perceptron algorithm, convolutional neural network algorithm, or other suitable machine-learning algorithm may be used to determine the detected external object based on the data from the IMU. Any number of features from the IMU data (or other sensor data) may be used to train the machine-learning algorithm and make this determination. In some illustrative examples, the position, acceleration, and rotation rate of the device may be used, as shown, for example in FIGS. 4A-4C. To train the algorithm, sample changes in position, acceleration, and/or rotation rate (and/or other features) when a proximity sensor is covered by a finger and when the device is lifted to the user's head may be used.

After training the algorithm with these sample features, the algorithm may be used to determine whether the proximity sensor is covered by a finger or whether the device is lifted to the user's head based on the position, acceleration, and rotation rate (and/or other inputs) of the device. In other words, finger/display determination 66 may be made. Finger/display determination 66 may be a determination of whether the external object sensed by the proximity sensor is a finger, such as a finger over display 14 and proximity sensor 30 of FIG. 2 (e.g., as opposed to the user holding the device to their head). In this way, the controller may determine whether a sensed external object is a user's finger or other object, or whether the user has brought the phone to their head.

Although finger/display determination 66 is described as determining whether a finger has triggered proximity sensor 30, this is merely illustrative. In general, finger/display determination may determine whether any suitable external object, such as a stylus, has triggered proximity sensor 30.

Suitable action may be taken based on determination 66. In particular, a display (e.g., display 14 of FIG. 1) may be deactivated if it is determined that the user has brought the device to their head. Doing so may reduce erroneous touch input that may occur as the user holds the device against their head/face. To deactivate the display, the controller (or other suitable circuitry) may disable a touch sensor in the display (or a portion of the touch sensor), may turn the display off (e.g., stop an array of pixels (or a portion of the array of pixels) of the display from emitting light), or otherwise may deactivate one or more functions of the display. In contrast, if it is determined that the proximity sensor has been triggered by a user's finger or other external object, the display may remain on (e.g., the display pixels may continue to emit light, and the touch sensor may remain enabled) to allow for user input and other interaction with the display. In this way, the display may remain on even when the proximity sensor detects the user's finger, allowing for a more seamless interaction with the electronic device.

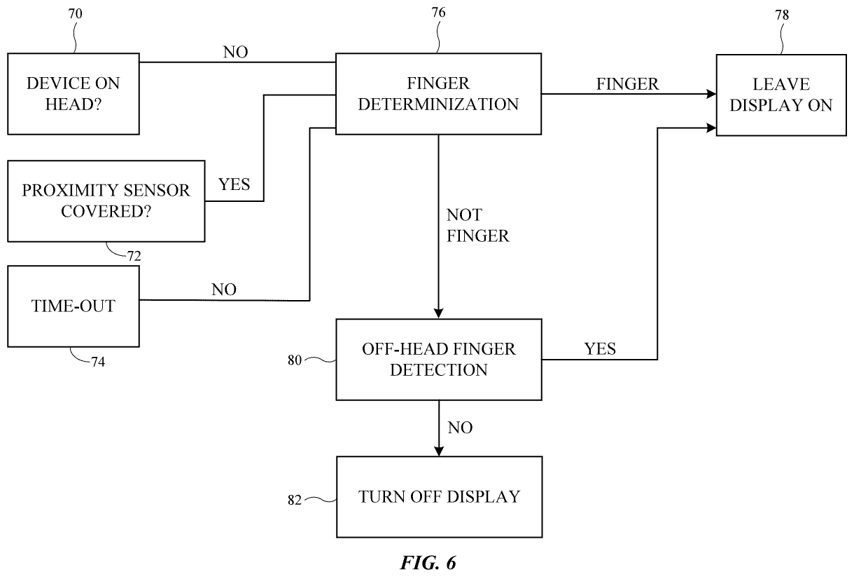

An illustrative diagram showing the process of determining whether a proximity sensor is triggered by a finger (or other object) or by a device being held to a user's head is shown in FIG. 6. As shown in FIG. 6, process 68 may begin with determination 70 of whether the device is already at the user's head (e.g., based on the most recent determination using process 68), determination 72 of whether the proximity sensor is covered/triggered (e.g., based on a measurement of a proximity sensor, such as proximity sensor 30 of FIGS. 2 and 3), and determination 74 of whether the process has timed out (e.g., one second, two seconds, or another suitable time frame has passed). If determination 70 is that the device is not already on the user's head, determination 72 is that the proximity has been triggered, and determination 74 is that the process has not timed out, then the process may proceed to finger determination 76. Otherwise, the device (e.g., a controller in the device) may wait until these determinations have been made before proceeding to finger determination 76.

Although FIG. 6 shows all three determinations 70, 72, and 74 needing to be made before the process proceeding to finger determination 76, this is merely illustrative. In general, any one or more of determinations 70, 72, and/or 74 (and/or other suitable determinations) may be made prior to proceeding to finger determination 76.

Finger determination 76 may use a machine-learning algorithm to correlate the motion data from an IMU in the electronic device to whether the proximity sensor was triggered due to the user's finger or the user lifting the device to their head. For example, a gradient boosted tree algorithm, random forest algorithm, decision tree algorithm, support vector machine algorithm, multi-layer perceptron algorithm, convolutional neural network algorithm, or other suitable machine-learning algorithm may be used to determine the detected external object based on the data from the IMU. Any number of features from the IMU data may be used to train the machine-learning algorithm and make this determination. In some illustrative examples, the position, acceleration, and rotation rate of the device may be used, as shown in FIGS. 4A-4C. To train the algorithm, sample changes in position, acceleration, and/or rotation rate (and/or other features) when a proximity sensor is covered by a finger and when the device is lifted to the user's head may be used.

After training the algorithm with these sample features, the algorithm may be used to determine whether the proximity sensor is covered by a finger or whether the device is lifted to the user's head based on the position, acceleration, and rotation rate (and/or other inputs) of the device. In other words, finger determination 76 may be made. Finger determination 76 may be a determination of whether the external object sensed by the proximity sensor is a finger, such as a finger over display 14 and proximity sensor 30 of FIG. 2 (e.g., as opposed to the user holding the device to their head). In this way, the controller may determine whether a sensed external object is a user's finger or other object, or whether the user has brought the phone to their head.

Although finger determination 76 is described as determining whether a finger has triggered proximity sensor 30, this is merely illustrative. In general, finger determination 76 may determine whether any suitable external object, such as a stylus, has triggered proximity sensor 30.

If it is determined that the external object that triggered the proximity sensor is a finger (or other external object, such as a stylus), process 68 may leave the display on, as indicated by box 78. In other words, the display pixels may continue to emit light, and the touch sensor may remain enabled, to allow for user input and other interaction with the display.

Alternatively, if it is determined that the external object is not a finger, a second algorithm may be used to make off-head finger detection 80. In particular, off-head finger detection 80 may determine whether the user has briefly removed the device from their head to interact with the display. Off-head finger detection 80 may be similar to finger determination 76, and may use motion data from the IMU to determine whether the user is briefly interacting with the display using their finger (e.g., with a machine-learning algorithm). If it is determined that the user is attempting to briefly interact with the display, process 68 may proceed to leave the display on, as indicated by box 78.

Alternatively, if it is determined that the user is not briefly attempting to interact with the display using their finger, it may be determined that the user is holding the device to their head (e.g., to make a phone call), and the display may be turned off/deactivated, as indicated by box 82. For example, a touch sensor (or a portion of the touch sensor) in the display may be deactivated, the display may be completely turned off (e.g., an array of pixels (or a portion of the array of pixels) of the display may stop emitting light), or one or more functions of the display may otherwise be deactivated. In this way, the display may be turned off/deactivated when it is determined that the user has raised the phone to their head, and erroneous touch input that may otherwise occur may be reduced or eliminated.

Although FIGS. 5 and 6 have shown and described the use of proximity information (e.g., data from proximity sensor 30) and motion information (e.g., motion data from IMU 62), other sensor information may be used in determining whether a proximity sensor has been triggered based on a user's finger or in response to the device being raised to the user's head. In general, data from other sensors may be used in combination with the motion data, if desired. For example, motion sensor data, ambient light sensor data, display touch sensor data, and/or other desired data may be used in determining whether the proximity sensor has been triggered by a user's finger or head.

As an illustrative example, ambient light sensor measurements may be lower when the device is brought to the user's head (e.g., the ambient light sensor may be at least partially covered, reducing the amount of ambient light that reaches the sensor) than when the user touches the display. Therefore, the ambient light sensor measurements may be used in combination with the IMU data to determine whether the display should remain on or be deactivated.

Alternatively or additionally, the display touch sensor may be used. In particular, the display touch sensor may receive a touch input that corresponds with the shape of a user's ear when the user holds the phone to their head (e.g., to make a phone call). In contrast, the display touch sensor may receive a touch input having a smaller area when the user is merely interacting with the display. Therefore, the display touch sensor measurements may be used in combination with the IMU data and/or the ambient light sensor measurements to determine whether the display should remain on or be deactivated.

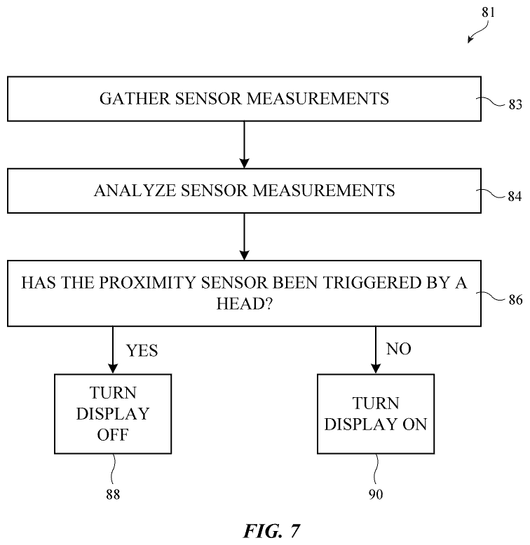

Regardless of the sensor(s) used in determining whether the external object that has triggered a proximity sensor, illustrative steps that may be used to make such a determination and to adjust the display based on that determination are shown in FIG. 7

As shown in method 81 of FIG. 7, at step 83, one or more sensors in an electronic device may gather sensor measurements. The sensor(s) may include a proximity sensor, an IMU, an ambient light sensor, a touch sensor, and/or other desired sensor(s). The sensor measurements may be analog or digital signals, and may form sensor data. In some embodiments, the sensor data may be gathered continuously (e.g., at regular frame rate intervals) while the electronic device is on. Alternatively, the sensor measurements may be gathered during specific time intervals. In an illustrative embodiment, proximity data from a proximity sensor (e.g., proximity sensor 30 of FIG. 5) and motion data from an IMU (e.g., IMU 62 of FIG. 5) may be gathered continuously at regular frame rate intervals while the device (and/or display) is on.

At step 84, the sensor measurements/data may be analyzed. For example, a controller, such as controller 16 in device 10 (FIG. 1), may analyze the proximity data and the motion data. In particular, the controller may first determine whether the proximity sensor has been triggered. In other words, the controller may determine whether an external object is within a threshold proximity of the proximity sensor.

In response to determining that the proximity sensor has been triggered by an external object, the controller may further analyze the data to determine whether the proximity sensor was triggered in response to the user lifting the device to their head (as opposed to merely touching the display). In particular, the controller may use a machine-learning algorithm to correlate the motion data from the IMU in the electronic device to whether the proximity sensor was triggered due to the user's finger or the user lifting the device to their head. For example, a gradient boosted tree algorithm, random forest algorithm, decision tree algorithm, support vector machine algorithm, multi-layer perceptron algorithm, convolutional neural network algorithm, or other suitable machine-learning algorithm may be used to determine the detected external object based on the data from the IMU. Any number of features from the IMU data may be used to train the machine-learning algorithm and make this determination. In some illustrative examples, the position, acceleration, and rotation rate of the device may be used, as shown in FIGS. 4A-4C. To train the algorithm, sample changes in position, acceleration, and/or rotation rate (and/or other features) when a proximity sensor is covered by a finger and when the device is lifted to the user's head may be used.

After training the algorithm with these sample features, the algorithm may be used to determine whether the proximity sensor is covered by a finger or whether the device is lifted to the user's head based on the position, acceleration, and rotation rate (and/or other inputs) of the device. In this way, the controller may determine whether a sensed external object is a user's finger or other object, or whether the user has brought the phone to their head.

At step 86, if the proximity sensor has been triggered by the user's head (e.g., if it has been determined that the user has brought the device to their head), the controller (or other circuitry) may proceed to step 88 and turn the display off. For example, a touch sensor (or a portion of the touch sensor) in the display may be deactivated, the display may be completely turned off (e.g., an array of pixels (or a portion of the array of pixels) of the display may stop emitting light), or one or more functions of the display may otherwise be deactivated. In this way, the display may be turned off/deactivated when it is determined that the user has raised the phone to their head, and erroneous touch inputs that may otherwise occur may be reduced or eliminated.

Alternatively, if it is determined that the proximity sensor has been triggered by the user touching the display with their finger or other external object (e.g., that the user has not raised the device to their head), the display may remain on, at step 90. In other words, the display pixels may continue to emit light, and the touch sensor may remain enabled, to allow for user input and other interaction with the display. In this way, the display may remain on even when the proximity sensor detects the user's finger, allowing for a more seamless interaction with the electronic device.

The foregoing is merely illustrative and various modifications can be made to the described embodiments. The foregoing embodiments may be implemented individually or in any combination.

What is claimed is:

1. An electronic device, comprising:
a housing;
a display in the housing and comprising an array of pixels configured to emit images and a touch sensor;
a proximity sensor in the housing configured to be triggered in response to a proximity of an external object;
an inertial measurement unit in the housing configured to measure a motion of the housing; and
a controller in the housing, wherein the controller is configured to determine, based on the motion of the housing, whether the proximity sensor has been triggered in response to a finger or in response to the housing being held to a head.

2. The electronic device of claim 1, wherein the controller is further configured to deactivate the display in response to determining that the proximity sensor has been triggered in response to the housing being held to the head.

3. The electronic device of claim 2, wherein the controller is configured to deactivate the display by deactivating the touch sensor in the display.

4. The electronic device of claim 3, wherein the controller is further configured to deactivate the display by turning off at least a portion of the array of pixels in the display.

5. The electronic device of claim 4, wherein the controller is further configured to leave the array of pixels and the touch sensor on in response to determining that the proximity sensor has been triggered in response to the finger.

6. The electronic device of claim 1, wherein the inertial measurement unit is configured to measure a position of the housing, an acceleration of the housing, and a rate of rotation of the housing.

7. The electronic device of claim 6, wherein the controller is configured to determine whether the proximity sensor has been triggered in response to the finger or in response to the housing being held to the head based on the position of the housing, the acceleration of the housing, and the rate of rotation of the housing.

8. The electronic device of claim 7, wherein the controller is configured to use a machine-learning algorithm that uses the position of the housing, the acceleration of the housing, and the rate of rotation of the housing as inputs to determine whether the proximity sensor has been triggered in response to the finger or in response to the housing being held to the head.

9. The electronic device of claim 1, wherein the proximity sensor is under the display.

10. The electronic device of claim 9, wherein the proximity sensor is an optical proximity sensor.

11. The electronic device of claim 1, wherein the controller is further configured to leave the array of pixels and the touch sensor on in response to determining that the proximity sensor has been triggered in response to the finger.

12. The electronic device of claim 1, wherein the inertial measurement unit comprises an accelerometer, a gyroscope, and a magnetometer.

13. A method of operating an electronic device with a display, a proximity sensor, and an inertial measurement unit, the method comprising:
gathering proximity sensor measurements with the proximity sensor and motion sensor measurements with the inertial measurement unit;
detecting an external object with the proximity sensor;
in response to detecting the external object, determining whether the external object is a finger of a user or a head of the user based on the motion sensor measurements; and
in response to determining that the external object is the head of the user, deactivating the display.

14. The method of claim 13, wherein determining whether the external object is the finger of the user or the head of the user based on the motion sensor measurements comprises inputting a position of the electronic device, an acceleration of the electronic device, and a rate of rotation of the electronic device into a machine-learning algorithm.

15. The method of claim 14, further comprising:
training the machine-learning algorithm based on known correlations between the position of the electronic device, the acceleration of the electronic device, and the rate of rotation of the electronic device and whether the external object is the finger of the user or the head of the user.

16. The method of claim 13, wherein deactivating the display comprises deactivating a touch sensor and an array of pixels of the display.

17. The method of claim 16, further comprising:
in response to determining that the external object is the finger of the user, leaving the touch sensor and the array of pixels of the display on.

18. An electronic device, comprising:
a housing;
a display in the housing;
a proximity sensor in the housing, wherein the proximity sensor is configured to be triggered in response to an external object;
a motion sensor in the housing, wherein the motion sensor is configured to measure a motion of the housing; and
a controller in the housing, wherein the controller is configured to determine, based on the motion of the housing, whether the proximity sensor has been triggered in response to a user's finger or in response to a user's head, and wherein the controller is configured to deactivate the display in response to determining that the proximity sensor has been triggered in response to the user's head.

19. The electronic device of claim 18, wherein the motion of the housing comprises a position of the housing, an acceleration of the housing, and a rate of rotation of the housing.

20. The electronic device of claim 19, wherein the motion sensor comprises an inertial measurement unit that includes an accelerometer, a gyroscope, and a magnetometer.
